(19) United States
(12) Patent Application Publication
(10) Pub. No.: US 2026/0194470 A1
(43) Pub. Date: Jul. 9, 2026

(54) ANALYSIS APPARATUS

(71) Applicant: FUJIFILM CORPORATION, Tokyo (JP)

(72) Inventor: Yoshinobu MIURA, Kanagawa (JP)

(21) Appl. No.: 19/558,477

(22) Filed: Mar. 6, 2026

Related U.S. Application Data
(63) Continuation of application No. PCT/JP2024/029691, filed on Aug. 21, 2024.

(30) Foreign Application Priority Data
Sep. 21, 2023 (JP) 2023-156444

(51) Int. Cl. G01N 21/84

(52) U.S. Cl. CPC G01N 21/8483

(57) ABSTRACT

There are included a loading section into which, as an analysis chip, a first analysis chip having a first reaction region in which a first reagent including a dry reagent is held or a second analysis chip having a second reaction region in which a second reagent not including the dry reagent is held is selectively loaded; a photometric unit including a photodetector that is disposed at a position at which the photodetector is capable of detecting both reflected light reflected at the first reaction region and transmitted light transmitted through the second reaction region, a first light source that emits first measurement light for obtaining the reflected light toward the first reaction region, and a second light source that emits second measurement light for obtaining the transmitted light toward the second reaction region; and a processor that controls the photometric unit.

### CROSS-REFERENCE TO RELATED APPLICATIONS

This application is a continuation of International Application No. PCT/JP2024/029691, filed on August 21, 2024, which claims priority from Japanese Patent Application No. 2023-156444, filed on September 21, 2023. The entire disclosure of each of the above applications is incorporated herein by reference.

### BACKGROUND

### Technical Field

The present disclosure relates to an analysis apparatus.

### Related Art

A known analysis apparatus analyzes a test substance sample by using an analysis chip onto which the test substance sample is spotted. As analysis of a test substance sample, for example, concentration of a detection target substance included in the test substance sample is measured by measuring a state of a reaction between the test substance sample and a reagent. The test substance sample is, for example, blood, urine, or the like. The analysis chip is typically an analysis chip including a reagent layer that includes a dry reagent.

In the analysis apparatus, measurement light is emitted to the reagent layer on which the test substance sample has been dropped with respect to such an analysis chip, reflected light thereof is detected, and a reaction product generated by a reaction between the detection target substance and the reagent is thereby detected. Therefore, the analysis apparatus includes a photometric unit that emits the measurement light with respect to the analysis chip and that detects the reflected light.

JP2016-526687A relates to a rapid diagnostic test cassette reader and discloses a configuration that enables detection of a test line in a reflection mode or a transmission mode depending on a cassette of an immunochromatographic assay.

### SUMMARY

An analysis chip (hereinafter referred to as a dry analysis chip) including a reagent layer that includes a dry reagent is easy to handle and enables simple measurement. On the other hand, a reaction between a dry reagent and a test substance sample is limited by the thickness of a reagent layer, and an optical path length of measurement light passing through a reaction layer between the reagent and the test substance sample is extremely short. Therefore, when the molecular weight of a reaction product is small or minute, it may be impossible to obtain sufficient sensitivity. Accordingly, when the molecular weight of a reaction product is small or minute, measurement using an analysis chip (hereinafter referred to as a wet analysis chip) in which a liquid reagent is held instead of a dry reagent is desirable.

The technology according to the present disclosure has been made in view of the above circumstances, and an object thereof is to provide an analysis apparatus capable of performing analysis using either of a dry analysis chip and a wet analysis chip.

An analysis apparatus according to the present disclosure is an analysis apparatus configured to analyze a test substance sample by using an analysis chip onto which the test substance sample is spotted, the analysis apparatus including:

a loading section into which, as the analysis chip, a first analysis chip having a first reaction region in which a first reagent including a dry reagent is held or a second analysis chip having a second reaction region in which a second reagent not including the dry reagent is held is selectively loaded;

a photometric unit that optically measures a reaction between a detection target substance in the test substance sample and the first reagent in the first reaction region or a reaction between the detection target substance and the second reagent in the second reaction region, the photometric unit including a photodetector that is disposed at a position at which the photodetector is capable of detecting both reflected light reflected at the first reaction region and transmitted light transmitted through the second reaction region, a first light source that emits first measurement light for obtaining the reflected light toward the first reaction region, and a second light source that emits second measurement light for obtaining the transmitted light toward the second reaction region; and a processor that controls the photometric unit,

in which the processor causes the photometric unit to perform measurement using the first light source when the analysis chip loaded into the loading section is the first analysis chip and causes the photometric unit to perform measurement using the second light source when the analysis chip loaded into the loading section is the second analysis chip.

In the analysis apparatus, the photodetector is preferably an area sensor.

The analysis apparatus preferably includes a temperature regulator that regulates a temperature of the first light source and a temperature of the second light source to be within a predetermined range of 30°C to 60°C.

Preferably, the analysis chip has a case on which information on presence or absence of the dry reagent is provided, the analysis apparatus further includes an information reader that reads the information provided on the case, and the processor is configured to selectively operate one of the first light source and the second light source based on the information acquired from the information reader.

The analysis chip may have a shape of a flat plate having a reaction region on a main surface thereof, the loading section may include a substrate on which the analysis chip is to be placed and a chip pressing portion that has a pressing surface arranged to face the reaction region of the analysis chip placed on the substrate and that presses the analysis chip, and the second light source may be installed inside the chip pressing portion and may emit the second measurement light to the reaction region through the pressing surface.

With the technology according to the present disclosure, it is possible to provide an analysis apparatus capable of performing analysis using either of a dry analysis chip and a wet analysis chip.

### BRIEF DESCRIPTION OF THE DRAWINGS

FIG. 1 is a schematic diagram of an analysis apparatus according to an embodiment;

FIG. 2 is a diagram illustrating a configuration of a first analysis chip having a dry reagent;

FIG. 3 is a diagram illustrating a configuration of a second analysis chip not having a dry reagent;

FIG. 4 is a schematic configuration diagram of a measurement unit of the analysis apparatus and illustrates a state in which a first analysis chip is loaded;

FIG. 5 is a schematic configuration diagram of the measurement unit of the analysis apparatus and illustrates a state in which a second analysis chip is loaded;

FIG. 6 is a diagram illustrating steps of a process in the measurement unit;

FIG. 7 is a diagram illustrating a configuration of the measurement unit according to a modification of the embodiment;

FIG. 8 is an image of a second reaction region photographed in an analysis apparatus in an example; and

FIG. 9 is a graph showing results of measurement performed by an analysis apparatus in an example.

### DESCRIPTION OF EMBODIMENTS

Hereinafter, a preferred embodiment of the present disclosure will be described with reference to the drawings. The same components are provided with the same reference signs in the drawings.

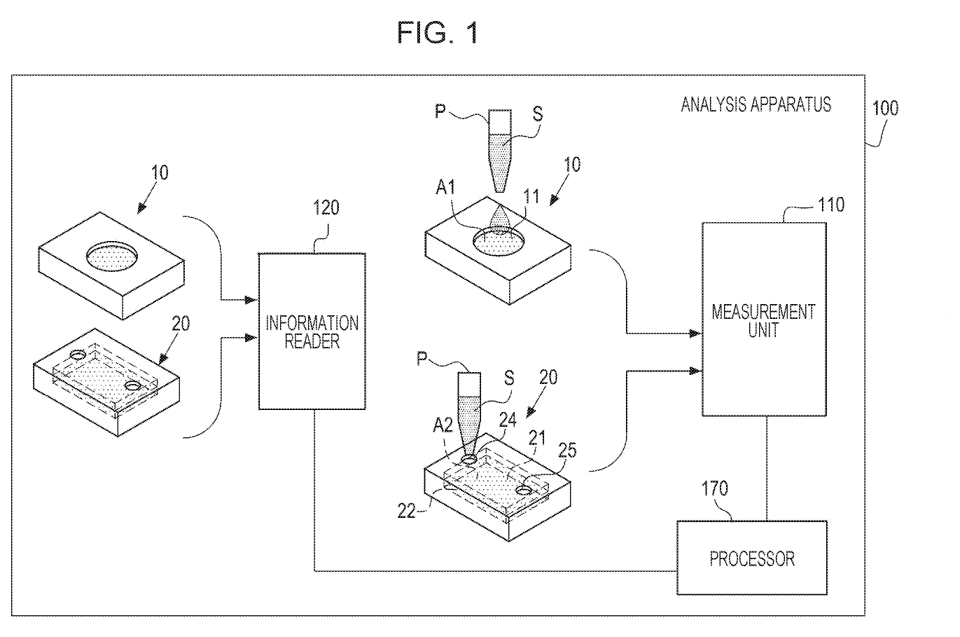

An analysis apparatus 100 according to an embodiment of the present disclosure illustrated in FIG. 1 is an example of an analysis apparatus configured to analyze a test substance sample and measures concentration of a detection target substance included in a test substance sample S by using, as analysis chips, two analysis chips including a first analysis chip 10 and a second analysis chip 20. More specifically, the analysis apparatus 100 in the present example uses blood as the test substance sample S and optically measures concentration of a detection target substance included in the blood. More specifically, the test substance sample S is, for example, whole blood, serum, or plasma.

The analysis apparatus 100 has a dispensing mechanism P, a measurement unit 110, an information reader 120, and a processor 170. The dispensing mechanism P supplies the test substance sample S to the first analysis chip 10 and the second analysis chip 20. The measurement unit 110 performs a process of measuring concentration of a detection target substance by using the first analysis chip 10 and the second analysis chip 20 to each of which the test substance sample S has been supplied. The first analysis chip 10 or the second analysis chip 20 is selectively loaded into the measurement unit 110. The information reader 120 reads whether an analysis chip loaded into the measurement unit 110 is the first analysis chip 10 or the second analysis chip 20. The processor 170 comprehensively controls each part of the analysis apparatus 100.

First, the two analysis chips 10 and 20 used for analysis in the analysis apparatus 100 will be described.

The first analysis chip 10 is a dry analysis chip and has a first reaction region A1 in which a first reagent 11, which is a dry reagent, is held. Here, the "dry analysis chip" means an analysis chip in which the first reagent 11 including a dry reagent is held. The first reagent 11 reacts with a detection target substance and thereby produces a substance that develops a specific color. The substance that develops a color due to the reaction is hereinafter referred to as a reactant. The first reagent 11 is a solid-phase dry reagent that is in a dry state at least at the time of shipment. The test substance sample S is spotted onto the first reaction region A1 of the first analysis chip 10 by the dispensing mechanism P.

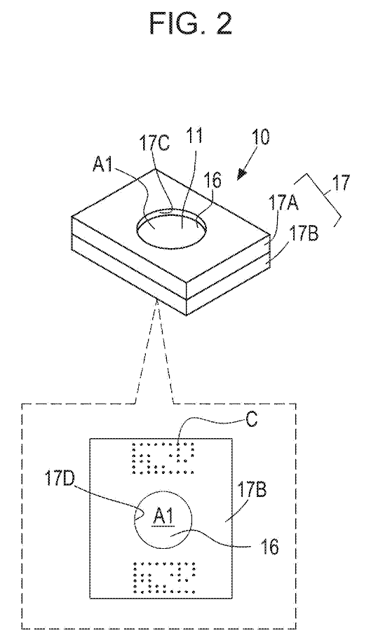

FIG. 2 is an external perspective view illustrating a structural example of the first analysis chip 10. As illustrated in FIG. 2, the first analysis chip 10 has a thin plate-like outer shape and has the first reaction region A1 in which the first reagent 11 is fixed at a central portion of the first reaction region A1.

The first analysis chip 10 has a carrier 16 onto which the test substance sample S is spotted, and the carrier 16 is accommodated in a case 17. The case 17 is constituted by a first case 17A and a second case 17B and accommodates the carrier 16 between the first case 17A and the second case 17B. The first case 17A has an opening 17C functioning as a dropping port through which the test substance sample S is to be spotted onto the first reaction region A1. The second case 17B has an opening 17D through which light is to be emitted to the first reaction region A1. The carrier 16 is exposed in the opening 17C of the first case 17A constituting the front surface of the first analysis chip 10. The carrier 16 is also exposed in the opening 17D of the second case 17B constituting the back surface of the first analysis chip 10. Regions exposed in the opening 17C and the opening 17D constitute the first reaction region A1.

The second analysis chip 20 is a wet analysis chip and has a second reaction region A2 in which a second reagent 21 not including a dry reagent is held. The second reagent 21 is a liquid reagent. The second analysis chip 20 has a liquid chamber 22 that accommodates the second reagent 21, and the liquid chamber 22 constitutes the second reaction region A2. Here, the "wet analysis chip" refers to an analysis chip that does not include, differently from the dry analysis chip, a carrier holding a dry reagent and that is to be used for analysis of a solution in which the test substance sample S is mixed with the second reagent 21 in a liquid state. The second reagent 21 may be accommodated in the liquid chamber 22 in advance, or the second reagent 21 may be supplied before or after the test substance sample S is supplied into the liquid chamber 22 by the dispensing mechanism P or may be supplied together with the test substance sample S. The second reagent 21 is, for example, a latex reagent including latex particles that aggregate by reacting with a detection target substance.

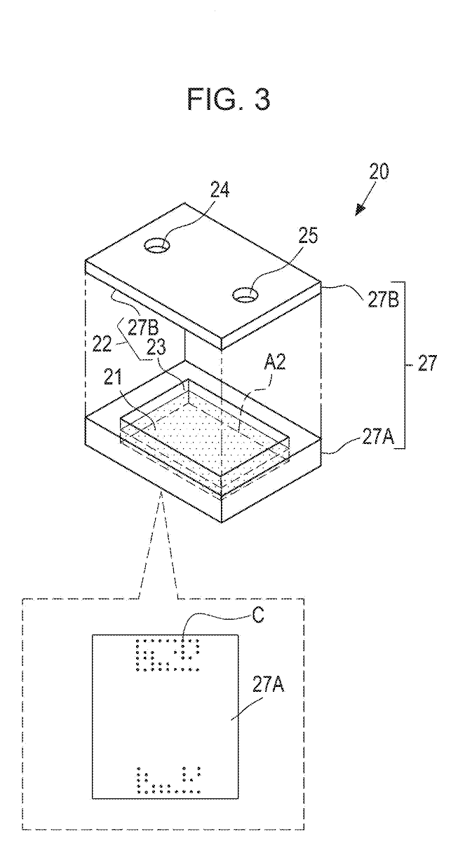

As illustrated in FIG. 1, the second analysis chip 20 has a thin plate-like outer shape similarly to the first analysis chip 10 and includes the liquid chamber 22 and openings 24 and 25 in communication with the liquid chamber 22 to allow supply of the test substance sample S and the second reagent 21 through the openings 24 and 25. FIG. 3 is an exploded perspective view of the second analysis chip 20.

In the second analysis chip 20, the liquid chamber 22 is enclosed in a case 27. The case 27 is constituted by a case body 27A on which a recess 23 is formed and a cover body 27B joined to the case body 27A so as to cover the recess 23. The liquid chamber 22 is constituted by the recess 23 of the case body 27A and the cover body 27B covering the recess 23. The cover body 27B has the two openings 24 and 25 in communication with the liquid chamber 22. In the present example, the second reagent 21 as a liquid reagent is, for example, accommodated in the liquid chamber 22 in advance. The test substance sample S is dispensed into the liquid chamber 22 through the opening 24 or the opening 25 by the dispensing mechanism P.

An information code C in which item information regarding a measurement item is encoded is provided on each of the first analysis chip 10 and the second analysis chip 20. In the first analysis chip 10 in the present example, the information code C is provided on the second case 17B constituting the back surface of the first analysis chip 10. In the second analysis chip 20 in the present example, the information code C is provided on the bottom surface of the case body 27A constituting the back surface of the second analysis chip 20. The item information is, for example, identification information (reagent name, identification code, and the like) of a reagent or identification information (item name, identification code, and the like) of a measurement item to be measured with the reagent. Since whether a reagent is a dry reagent or a liquid reagent is specified by the type of the reagent, the identification information of the reagent is an example of "information on presence or absence of the dry reagent" in the technology according to the present disclosure. A detection target substance to be detected on the first analysis chip 10 and a detection target substance to be detected on the second analysis chip 20 are different from each other.

The information reader 120 is, for example, a code reader that reads the information codes C provided on the first analysis chip 10 and the second analysis chip 20. For example, the information reader 120 is constituted by an image sensor, such as a charge coupled device (CCD) or a complementary metal oxide semiconductor (CMOS). Each information code C read by the information reader 120 is output to the processor 170. The processor 170 acquires the information code C from the information reader 120 and specifies whether an analysis chip to be loaded is the first analysis chip 10 or the second analysis chip 20.

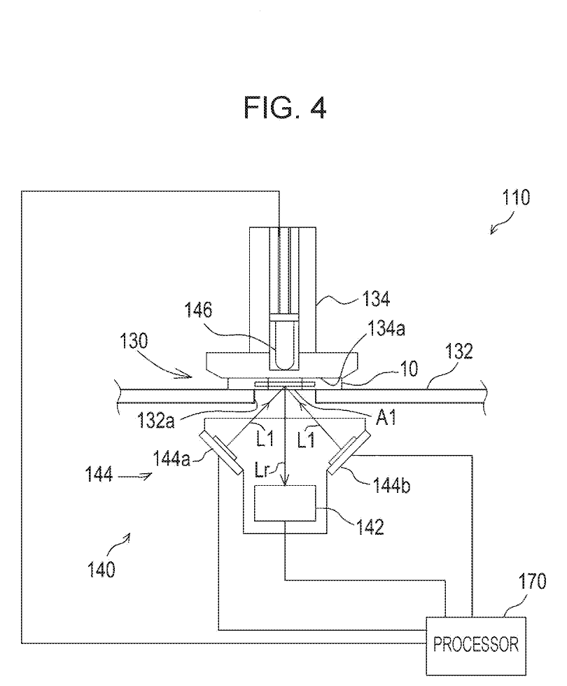

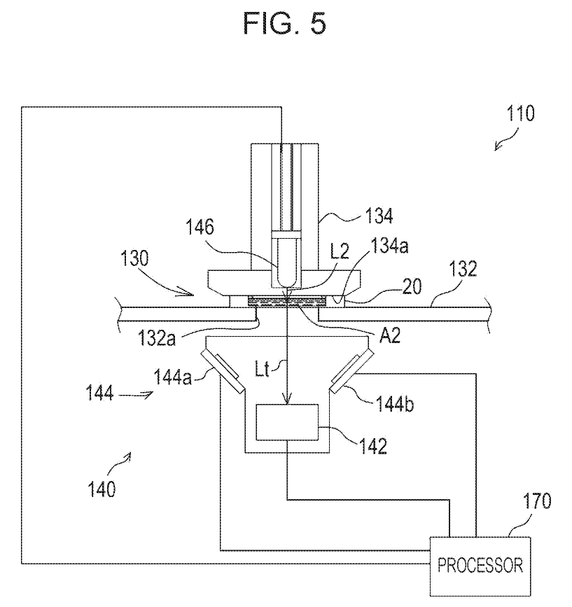

A configuration of the measurement unit 110 of the analysis apparatus 100 will be described with reference to FIG. 4 and FIG. 5. The measurement unit 110 includes a loading section 130 and a photometric unit 140. The first analysis chip 10 or the second analysis chip 20 serving as a measurement target is selectively loaded and held in the loading section 130. FIG. 4 illustrates a state in which the first analysis chip 10 having the first reagent 11 is loaded in the loading section 130. FIG. 5 illustrates a state in which the second analysis chip 20 having the second reagent 21 is loaded in the loading section 130.

In the present example, the loading section 130 is constituted by a substrate 132 and a chip pressing portion 134. The first analysis chip 10 or the second analysis chip 20 is selectively placed on the substrate 132. The chip pressing portion 134 has a pressing surface 134a disposed to face the first reaction region A1 of the first analysis chip 10 or the second reaction region A2 of the second analysis chip 20 placed on the substrate 132, and presses the first analysis chip 10 or the second analysis chip 20 loaded in the loading section 130.

Using the first analysis chip 10 on which the test substance sample S has been spotted, the photometric unit 140 acquires a detection signal indicating optical density of the first reaction region A1. In addition, using the second analysis chip 20 on which the test substance sample S has been dispensed, the photometric unit 140 acquires a detection signal indicating optical density of the second reaction region A2.

The photometric unit 140 includes a photodetector 142, a first light source 144, and a second light source 146. The photometric unit 140 optically measures a reaction between a detection target substance and the first reagent 11 in the first reaction region A1 or a reaction between a detection target substance and the second reagent 21 in the second reaction region A2.

The photodetector 142 is disposed at a position at which the photodetector 142 can detect both reflected light Lr reflected at the first reaction region A1 and transmitted light Lt transmitted through the second reaction region A2. In the present example, the photodetector 142 is disposed at a position below the first analysis chip 10 or the second analysis chip 20 loaded in the loading section 130 and facing the first analysis chip 10 or the second analysis chip 20.

As illustrated in FIG. 4, the first light source 144 emits the first measurement light L1 for obtaining the reflected light Lr toward the first reaction region A1. In the present example, the first light source 144 includes two light sources 144a and 144b. The light source 144b is disposed at a position rotated from the light source 144a by approximately 180° about an axis of the reflected light. The two light sources 144a and 144b each emit the first measurement light L1 to the first reaction region A1 in a direction inclined with respect to a normal line of the first reaction region A1 of the first analysis chip 10 loaded in the loading section 130. Then, the reflected light Lr from the first reaction region A1 irradiated with the first measurement light L1 is detected by the photodetector 142.

As illustrated in FIG. 5, the second light source 146 emits second measurement light L2 for obtaining the transmitted light Lt toward the second reaction region A2. In the present example, the second light source 146 is embedded in the chip pressing portion 134 of the loading section 130. At least a portion of the chip pressing portion 134 serving as an optical path for the second measurement light L2 is made of a material transparent or translucent with respect to the second measurement light L2. The second reaction region A2 of the second analysis chip 20 is irradiated with the second measurement light L2 output from the second light source 146, and the transmitted light Lt thereof is detected by the photodetector 142.

The photodetector 142 is, for example, a light-receiving element, such as a photodiode, that outputs a detection signal corresponding to the amount of light. The photodetector 142 is not limited to a single light-receiving element and may have a plurality of light-receiving elements. Alternatively, an area sensor may be used as the photodetector 142. The area sensor is, for example, a CMOS image sensor or a CCD image sensor and has a capturing surface on which a plurality of light-receiving elements are two-dimensionally arranged.

As described above, a reaction between a detection target substance and the first reagent 11 produces a reactant that develops a specific color. Since the first measurement light L1 emitted by the first light source 144 is light for detecting whether a reactant has been generated, a wavelength range is determined depending on a color developed by the reactant. As already described, for example, in order to detect a reactant, the first measurement light L1 is light that includes a wavelength range absorbed by the reactant.

The wavelength range of the first measurement light L1 is preferably limited to a wavelength range absorbed by the reactant. This is because light of such a wavelength range has the highest contrast of optical density depending on presence or absence of the reactant. As the first light source 144, for example, a light source such as a light emitting diode (LED), an electro luminescence (EL) device, or a semiconductor laser is used. Detection light limited to a specific wavelength range may be generated by a combination of a light source, such as a white light source, that emits light in a relatively broad wavelength range and a band-pass filter that transmits only the specific wavelength range.

The second measurement light L2 is also allowed to have a wavelength selected depending on the second reagent 21. For example, when the second reagent 21 is a latex reagent, in order to detect a change in absorbance due to a latex agglutination reaction, the second measurement light L2 is set to a wavelength range absorbed by a latex agglutinate. As the second light source 146, for example, a light source such as an LED, an organic EL device, or a semiconductor laser is also used.

The processor 170 comprehensively controls each part of the analysis apparatus 100. The photometric unit 140 is also controlled by the processor 170. The processor 170 is constituted by, for example, a central processing unit (CPU) and executes a process of measuring in the analysis apparatus 100 by executing a program.

The processor 170 specifies whether an analysis chip loaded into the loading section 130 is the first analysis chip 10 or the second analysis chip 20, on the basis of the information code C acquired from the information reader 120. The processor 170 causes the photometric unit 140 to perform measurement using the first light source 144 when the analysis chip loaded into the loading section 130 is the first analysis chip 10 and causes the photometric unit 140 to perform measurement using the second light source 146 when the analysis chip loaded into the loading section 130 is the second analysis chip 20. When measurement using the first light source 144 is performed, the processor 170 acquires, from the photodetector 142, a first detection signal corresponding to the reflected light Lr detected by the photodetector 142 and derives concentration of a detection target substance on the basis of the first detection signal. When the measurement using the second light source 146 is performed, the processor 170 acquires, from the photodetector 142, a second detection signal corresponding to the transmitted light Lt detected by the photodetector 142 and derives concentration of a detection target substance on the basis of the second detection signal.

In the examples in FIG. 4 and FIG. 5, the photodetector 142 is disposed at a position facing an opening 132a provided in the substrate 132 of the loading section 130. The opening 132a is provided at a position at which the opening 17D of the case 17 of the first analysis chip 10 loaded in the loading section 130 is exposed, and the position corresponds to the liquid chamber 22 of the second analysis chip 20 loaded in the loading section 130. The two light sources 144a and 144b constituting the first light source 144 are each disposed at a position at which the first measurement light L1 is emitted obliquely to the opening 17D. The second light source 146 is disposed at a position opposite the photodetector 142 and at which the second measurement light L2 is emitted perpendicularly to the second reaction region A2. Such a layout of the photodetector 142, the first light source 144, and the second light source 146 is an example and can be variously modified. For example, when a light guiding member that guides the first measurement light L1, the reflected light Lr, the second measurement light L2, or the transmitted light Lt is used between the opening 132a of the substrate 132 and each of the photodetector 142 and the first light source 144 and/or between the liquid chamber 22 of the second analysis chip 20 and each of the photodetector 142 and the second light source 146, the positions of the photodetector 142, the first light source 144, and the second light source 146 can be moved to various positions.

A procedure of a process in the analysis apparatus 100 according to the first embodiment is as follows.

First, the information code C of the first analysis chip 10 or the second analysis chip 20 loaded into the measurement unit 110 is read by the information reader 120. The information code C read by the information reader 120 is output to the processor 170.

The test substance sample S is dispensed by the dispensing mechanism P to the first analysis chip 10 or the second analysis chip 20 from which the information code C has been read by the information reader 120. The test substance sample S is spotted onto the first reaction region A1 in the first analysis chip 10, and the test substance sample S is dispensed into the liquid chamber 22, that is, onto the second reaction region A2 in the second analysis chip 20. Thereafter, the first analysis chip 10 or the second analysis chip 20 is loaded into the measurement unit 110. In the measurement unit 110, measurement is performed on the loaded first analysis chip 10 or second analysis chip 20.

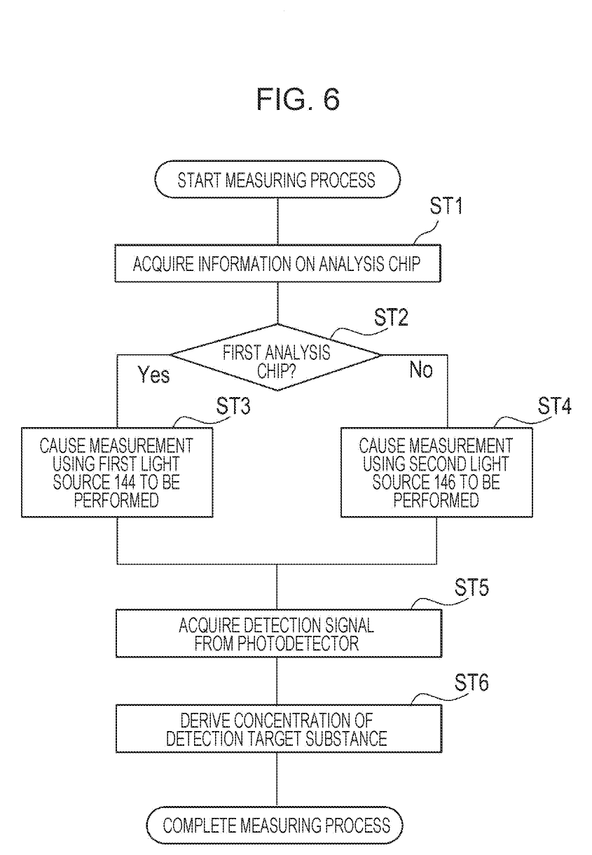

FIG. 6 illustrates steps of a process performed by the processor 170 of the measurement unit 110.

First, the processor 170 acquires, from the information reader 120, information indicating whether the loaded analysis chip is the first analysis chip 10 or the second analysis chip 20 (step ST1). The timing of acquiring this information may be before or after the analysis chip is loaded in the loading section 130.

When the loaded analysis chip is the first analysis chip 10 (step ST2: Yes), the processor 170 causes the photometric unit 140 to perform measurement using the first light source 144 (step ST3). Consequently, the first measurement light L1 is emitted from the first light source 144 to the first reaction region A1 of the first analysis chip 10, and the reflected light Lr thereof is detected by the photodetector 142.

When the loaded analysis chip is the second analysis chip 20 (step ST2: No), the processor 170 causes the photometric unit 140 to perform measurement using the second light source 146 (step ST4). Consequently, the second measurement light L2 is emitted from the second light source 146 to the second reaction region A2 of the second analysis chip 20, and the transmitted light Lt thereof is detected by the photodetector 142.

The processor 170 acquires a detection signal from the photodetector 142 (step ST5). The detection signal acquired from the photodetector 142 is the first detection signal corresponding to the reflected light Lr or the second detection signal corresponding to the transmitted light Lt.

The processor 170 executes a step of deriving concentration of a detection target substance on the basis of the first detection signal or the second detection signal (step ST6). Consequently, a process of measuring with respect to the first analysis chip 10 or the second analysis chip 20, which is the analysis chip loaded in the loading section 130, is completed.

Thus, the analysis apparatus 100 according to the present embodiment includes the loading section 130 into which the first analysis chip 10 having a dry reagent or the second analysis chip 20 not having the dry reagent is selectively loaded, and the photometric unit 140 including the photodetector 142 disposed at a position at which the photodetector 142 can detect both the reflected light Lr reflected at the first reaction region A1 of the first analysis chip 10 and the transmitted light Lt transmitted through the second reaction region A2 of the second analysis chip 20, the first light source 144 that emits the first measurement light L1 for obtaining the reflected light Lr toward the first reaction region A1, and the second light source 146 that emits the second measurement light L2 for obtaining the transmitted light Lt toward the second reaction region A2. The analysis apparatus 100 having such a configuration is capable of performing analysis using either a dry analysis chip or a wet analysis chip. By detecting the reflected light Lr of the first measurement light L1 with respect to the first analysis chip 10 and detecting the transmitted light Lt of the second measurement light L2 with respect to the second analysis chip 20, it is possible to perform measurement suitable for each of a dry type and a wet type and to obtain a highly accurate measurement result for each detection target substance. An appropriate analysis chip can be selectively used depending on a test target substance, such that the second analysis chip 20, which is a wet analysis chip, is used when the molecular weight of a reaction product generated by a reaction of the detection target substance with a reagent is small or minute while the first analysis chip 10, which is a dry analysis chip, is used when the molecular weight of the reaction product is relatively large. In the analysis apparatus 100, the loading section 130 and the photometric unit 140 are used in common for the first analysis chip 10 and the second analysis chip 20, and the apparatus can be configured to be compact compared with a case where different loading sections and different photometric units are included for the first analysis chip 10 and the second analysis chip 20.

In the present example, the processor 170 specifies the first analysis chip 10 or the second analysis chip 20 on the basis of an information code acquired from the information reader 120, and causes the photometric unit 140 to perform measurement using the first light source 144 or measurement using the second light source 146. When it is configured as described above such that, in the analysis apparatus 100, a type of an analysis chip is read and a light source to be operated is selected depending on the type of the analysis chip, a user does not need to specify the type of the analysis chip, which is highly convenient.

However, the analysis apparatus according to the present disclosure may be configured such that the information reader 120 is not included and information indicating whether a loaded analysis chip is the first analysis chip 10 or the second analysis chip 20 is input to the analysis apparatus 100 from external input means.

When an area sensor is used as the photodetector 142 of the photometric unit 140 in the analysis apparatus 100, "detecting the reflected light Lr from the first reaction region A1" means capturing an image of the first reaction region A1, and "detecting the transmitted light Lt transmitted through the second reaction region A2" means capturing an image of the second reaction region A2. When the second analysis chip 20 is used, air bubbles may be generated in liquid including a liquid reagent (second reagent 21) and the test substance sample S in the liquid chamber 22. Generation of air bubbles affects the amount of the transmitted light Lt. When the amount of detected light, that is, detected optical density fluctuates due to presence or absence of air bubbles, a detection error in concentration of a detection target substance may be generated as a result. When an image is captured using an area sensor, presence or absence of air bubbles in the second reaction region A2 can be easily detected. Therefore, in a case where air bubbles are generated, it is possible to perform a process of, for example, issuing an alert to notify a user or detecting optical density from data from which the part of the air bubbles is excluded, and it is possible to suppress an influence of the air bubbles on a measurement result.

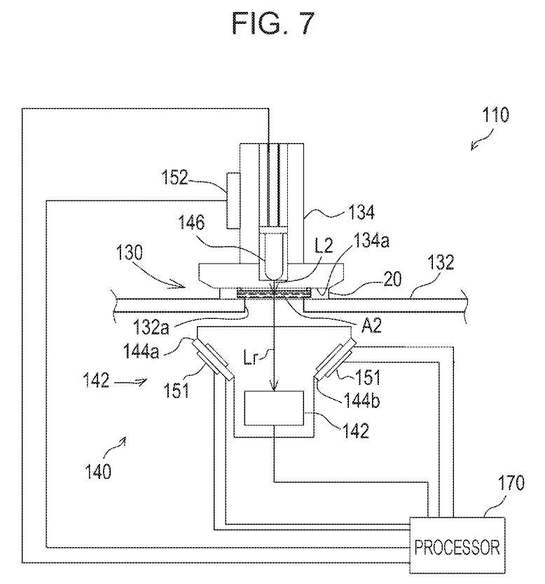

In the analysis apparatus 100, as illustrated in FIG. 7, the measurement unit 110 preferably further includes a first temperature regulator 151 that regulates the temperature of the first light source 144 and a second temperature regulator 152 that regulates the temperature of the second light source 146. The first temperature regulator 151 and the second temperature regulator 152 each include, for example, a heater and a temperature sensor.

In the example illustrated in FIG. 7, the first temperature regulator 151 is included, for example, in the substrate back surface of each of the two light sources 144a and 144b constituting the first light source 144. The second temperature regulator 152 is included in the chip pressing portion 134. When the chip pressing portion 134 is a member made of metal or the like and having high thermal conductivity, the temperature of the second light source 146 can be regulated by the second temperature regulator 152 included in an outer portion of the chip pressing portion 134. The arrangement of the first temperature regulator 151 and the second temperature regulator 152 is not limited to this form. The first temperature regulator 151 and the second temperature regulator 152 may be included in any portions as long as the first temperature regulator 151 and the second temperature regulator 152 can control the temperatures of the first light source 144 and the second light source 146, respectively.

The first temperature regulator 151 and the second temperature regulator 152 are also controlled by the processor 170. The processor 170 controls the first temperature regulator 151 and the second temperature regulator 152 such that the temperature of each of the first light source 144 and the second light source 146 is within a predetermined range of 30°C to 60°C. Temperature fluctuation may cause the amounts of the measurement light L1 and L2 to vary. Since the amount of the reflected light Lr and the amount of the transmitted light Lt vary depending on the amount of the measurement light L1 and the amount of the measurement light L2, respectively, fluctuation in the amounts of the measurement light L1 and L2 generates an error in measured concentration of a detection target substance. By including the temperature regulator 151 and the temperature regulator 152 and regulating the temperature of each of the first light source 144 and the second light source 146 to a temperature within a certain temperature range, it is possible to suppress measurement errors. The predetermined range of 30°C to 60°C means a range within a specific temperature ±several degrees in the temperature range of 30°C to 60°C, and is, for example, a range such as 40°C ±3°C.

In the above-described embodiment, various types of processors (processer) presented below are usable as a hardware structure of the processor 170. In addition to a CPU, which is a general-purpose processor functioning as various types of processing units by executing software (programs), the various types of processors include a programmable logic device (PLD), such as a field-programmable gate array (FPGA), whose circuit configuration can be changed after manufacture and a dedicated electric circuit, such as an application specific integrated circuit (ASIC), which is a processor having a circuit configuration designed exclusively for executing a specific process.

The above-described process may be executed by one of these various types of processors or may be executed by a combination of two or more processors of the same type or different types (for example, a plurality of FPGAs, a combination of a CPU and a FPGA, or the like). A plurality of processing units may be constituted by a single processor. An example in which a plurality of processing units are constituted by a single processor is a form using a processor that realizes functions of the entire system including a plurality of processing units by a single integrated circuit (IC) chip, similarly to a system on chip (SOC).

Further, as a hardware structure of these processors, more specifically, an electric circuit (circuitry) in which circuit elements, such as semiconductor elements, are combined together is usable.

In addition, the technology according to the present disclosure is also extended to, in addition to an operation program of an analysis apparatus, a computer-readable storage medium (a USB memory, a digital versatile disc (DVD)-read only memory (ROM), or the like) that non-transitorily stores an operation program of an analysis apparatus.

### Example

A prototype of an analysis apparatus was fabricated by replacing a photometric unit in an existing analysis apparatus for dry analysis chips (for example, the apparatus disclosed in WO2013/161664A) with the photometric unit 140, which is illustrated in FIG. 4 and FIG. 5, having the photodetector 142, the first light source 144, and the second light source 146 disposed in the chip pressing portion 134. The prototype analysis apparatus has a configuration capable of performing measurement using a dry analysis chip in the same manner as in the related art. A CMOS camera was disposed as the photodetector 142, and a detection target substance in a test substance sample was measured using the second analysis chip 20, which is a wet analysis chip.

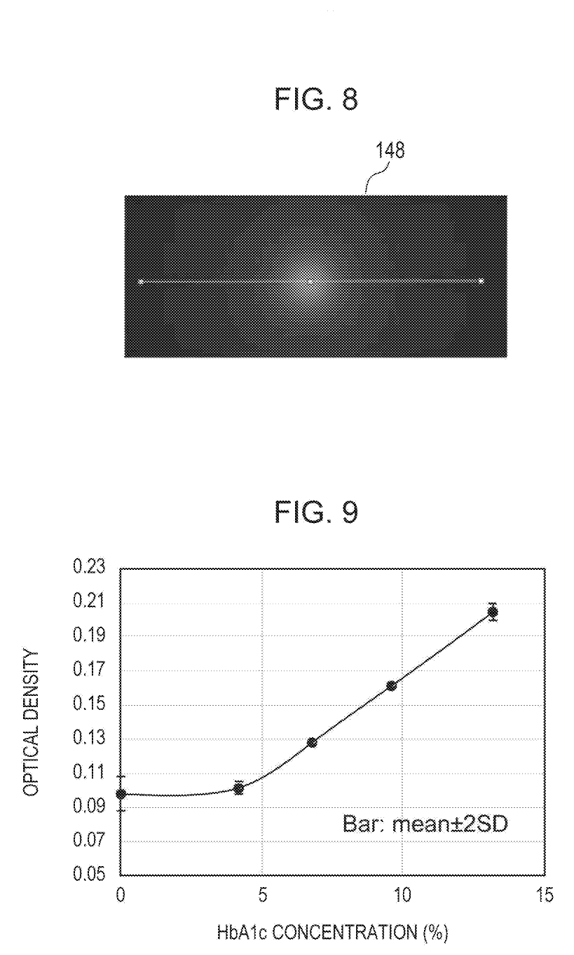

FIG. 8 illustrates an image 148 of the second reaction region A2 obtained by irradiating the second reaction region A2 of the second analysis chip 20 with the second measurement light L2 by the second light source 146 and capturing the transmitted light Lt by the CMOS camera.

Here, HbA1c (hemoglobin A1c) was measured using a latex agglutination turbidimetric immunoassay. A plurality of test substance samples having different HbA1c concentrations were prepared, and the image 148 of the second reaction region A2, such as that illustrated in FIG. 8, was obtained for each test substance sample. In the image 148 obtained for each of the test substance samples, a brightness value profile indicating a relationship between a position on a horizontal line (see FIG. 8) passing through an optical axis and a brightness value was derived by image analysis, and a peak value of the profile was converted into optical density. As a result, as FIG. 9 shows, optical density proportional to HbA1c concentration was obtained. The optical density in FIG. 9 represents the mean (n = 3) of three measurements performed for each HbA1c concentration.

As described above, by applying the measurement unit 110 of the analysis apparatus 100 according to the above-described embodiment to an existing analysis apparatus for dry analysis chips, it is possible to realize an analysis apparatus compatible with both dry analysis chips and wet analysis chips.

It should be noted that the content described above and the content illustrated in the drawings are detailed description of parts related to the technology according to the present disclosure and are merely examples of the technology according to the present disclosure. For example, the above description regarding configurations, functions, operations, and effects is description regarding examples of configurations, functions, operations, and effects of parts related to the technology according to the present disclosure. Therefore, it is needless to say that, within a range not deviating from the spirit of the technology according to the present disclosure, unnecessary parts may be deleted from, new elements may be added to, or replacements may be made to the content described above and the content illustrated in the drawings. In addition, in order to avoid complication and to facilitate understanding of the parts related to the technology according to the present disclosure, description related to common general technical knowledge and the like for which description is not particularly required for enabling implementation of the technology according to the present disclosure is omitted in the content described above and the content illustrated in the drawings.

The disclosure of JP2023-156444 filed on September 21, 2023 is incorporated in the present specification by reference in its entirety. All documents, patent applications, and technical standards mentioned in the present specification are incorporated in the present specification by reference to the same extent as if each individual document, patent application, or technical standard was specifically and individually indicated to be incorporated herein by reference.

Regarding the above embodiment, the following appendixes are further disclosed.

### Appendix 1

An analysis apparatus configured to analyze a test substance sample by using an analysis chip onto which the test substance sample is spotted, the analysis apparatus including:

a loading section into which, as the analysis chip, a first analysis chip having a first reaction region in which a first reagent including a dry reagent is held or a second analysis chip having a second reaction region in which a second reagent not including the dry reagent is held is selectively loaded;

a photometric unit that optically measures a reaction between a detection target substance in the test substance sample and the first reagent in the first reaction region or a reaction between the detection target substance and the second reagent in the second reaction region, the photometric unit including a photodetector that is disposed at a position at which the photodetector is capable of detecting both reflected light reflected at the first reaction region and transmitted light transmitted through the second reaction region, a first light source that emits first measurement light for obtaining the reflected light toward the first reaction region, and a second light source that emits second measurement light for obtaining the transmitted light toward the second reaction region; and

a processor that controls the photometric unit,

in which the processor causes the photometric unit to perform measurement using the first light source when the analysis chip loaded into the loading section is the first analysis chip and causes the photometric unit to perform measurement using the second light source when the analysis chip loaded into the loading section is the second analysis chip.

### Appendix 2

The analysis apparatus according to Appendix 1, in which the photodetector is an area sensor.

### Appendix 3

The analysis apparatus according to Appendix 1 or Appendix 2, including a temperature regulator that regulates a temperature of the first light source and a temperature of the second light source to be within a predetermined range of 30°C to 60°C.

### Appendix 4

The analysis apparatus according to any one of Appendix 1 to Appendix 3,

in which the analysis chip has a case on which information on presence or absence of the dry reagent is provided,

in which the analysis apparatus further includes an information reader that reads the information provided on the case, and

in which the processor selectively operates one of the first light source and the second light source based on the information acquired from the information reader.

### Appendix 5

The analysis apparatus according to any one of Appendix 1 to Appendix 4,

in which the analysis chip has a shape of a flat plate having a reaction region on a main surface thereof,

in which the loading section includes a substrate on which the analysis chip is to be placed, and a chip pressing portion that has a pressing surface arranged to face the reaction region of the analysis chip placed on the substrate and that presses the analysis chip; and

in which the second light source is installed inside the chip pressing portion and emits the second measurement light to the reaction region through the pressing surface.

What is claimed is:

1. An analysis apparatus configured to analyze a test substance sample by using an analysis chip onto which the test substance sample is spotted, the analysis apparatus comprising:
a loading section into which, as the analysis chip, a first analysis chip having a first reaction region in which a first reagent including a dry reagent is held or a second analysis chip having a second reaction region in which a second reagent not including the dry reagent is held is selectively loaded;
a photometric unit that optically measures a reaction between a detection target substance in the test substance sample and the first reagent in the first reaction region or a reaction between the detection target substance and the second reagent in the second reaction region, the photometric unit including a photodetector that is disposed at a position at which the photodetector is capable of detecting both reflected light reflected at the first reaction region and transmitted light transmitted through the second reaction region, a first light source that emits first measurement light for obtaining the reflected light toward the first reaction region, and a second light source that emits second measurement light for obtaining the transmitted light toward the second reaction region; and
a processor that controls the photometric unit,
wherein the processor is configured to cause the photometric unit to perform measurement using the first light source when the analysis chip loaded into the loading section is the first analysis chip and causes the photometric unit to perform measurement using the second light source when the analysis chip loaded into the loading section is the second analysis chip.

2. The analysis apparatus according to claim 1, wherein the photodetector is an area sensor.

3. The analysis apparatus according to claim 1, comprising a temperature regulator that regulates a temperature of the first light source and a temperature of the second light source to be within a predetermined range of 30°C to 60°C.

4. The analysis apparatus according to claim 2, comprising a temperature regulator that regulates a temperature of the first light source and a temperature of the second light source to be within a predetermined range of 30°C to 60°C.

5. The analysis apparatus according to claim 1,
wherein the analysis chip has a case on which information on presence or absence of the dry reagent is provided,
wherein the analysis apparatus further includes an information reader that reads the information provided on the case, and
wherein the processor selectively operates one of the first light source and the second light source based on the information acquired from the information reader.

6. The analysis apparatus according to claim 2,
wherein the analysis chip has a case on which information on presence or absence of the dry reagent is provided,
wherein the analysis apparatus further includes an information reader that reads the information provided on the case, and
wherein the processor selectively operates one of the first light source and the second light source based on the information acquired from the information reader.

7. The analysis apparatus according to claim 1,
wherein the analysis chip has a shape of a flat plate having a reaction region on a main surface thereof,
wherein the loading section includes a substrate on which the analysis chip is to be placed, and a chip pressing portion that has a pressing surface arranged to face the reaction region of the analysis chip placed on the substrate and that presses the analysis chip; and
wherein the second light source is installed inside the chip pressing portion and emits the second measurement light to the reaction region through the pressing surface.

8. The analysis apparatus according to claim 2,
wherein the analysis chip has a shape of a flat plate having a reaction region on a main surface thereof,
wherein the loading section includes a substrate on which the analysis chip is to be placed, and a chip pressing portion that has a pressing surface arranged to face the reaction region of the analysis chip placed on the substrate and that presses the analysis chip; and
wherein the second light source is installed inside the chip pressing portion and emits the second measurement light to the reaction region through the pressing surface.
